(19) United States
(12) Patent Application Publication
(10) Pub. No.: US 2023/0226388 A1
(43) Pub. Date: Jul. 20, 2023

(54) ROPE LOCKING APPARATUS

(71) Applicant: FICONT INDUSTRY (BEIJING) CO., LTD., Beijing (CN)

(72) Inventors: Yongqiang SONG, Beijing (CN); Zizhao LIU, Beijing (CN); Zhixin LIU, Beijing (CN)

(21) Appl. No.: 17/997,105

(22) PCT Filed: Sep. 29, 2020
(86) PCT No.: PCT/CN2020/118918

§ 371 Date: Oct. 25, 2022

(30) Foreign Application Priority Data
Aug. 18, 2020 (CN) 202010833203.4

(51) Int. Cl. A62B 35/00

(52) U.S. Cl. CPC A62B 35/0093

(57) ABSTRACT

A rope locking apparatus, comprising: a locking member (11) adapted to switching between a locked state and an unlocked state with a rope (100); a roller (22) adapted to being pressed against the surface of the rope (100) under the action of a pressing member; a rotating shaft (25) adapted to rotating along with the roller (22); a centrifugal member, which is mounted on the rotating shaft (25) and rotates along with the rotating shaft (25), wherein the centrifugal member switches between a centrifugal state and a reset state along with change in a centrifugal force; and a driving member, wherein the centrifugal member in the centrifugal state drives the driving member to move, so that the locking member (11) moves until same is in the locked state; and the centrifugal member in the reset state is separated from the driving member, so that the locking member (11) is in the unlocked state.

### CROSS-REFERENCE TO RELATED APPLICATION

The present is the U.S. National Phase under 35. U.S.C. § 371 of International Application PCT/CN2020/118918, filed Sep. 29, 2020, which application claims priority to Chinese Application No. 202010833203.4 filed on Aug. 18, 2020, entitled “Rope Locking Apparatus”, which is hereby incorporated by reference in its entirety.

### TECHNICAL FIELD

The present application relates to a rope locking apparatus.

### BACKGROUND

The statements herein merely provide background information related to the present application and do not necessarily constitute prior art.

In order to ensure the safety of aerial staff during construction, it is necessary to arrange fall protection equipment with reliable performance The rope locking apparatus is an important fall protection equipment connecting a rope and a worker. The structure of the traditional rope locking apparatus can be referred to FIG. 1 to FIG. 4. As shown in FIG. 1 and FIG. 2, when a worker falls, a carabiner 003 pulls a driving lever 001, then the locking surface on the driving lever 001 swings towards the rope until the locking surface and the rope are clamped tightly to realize a locking effect and prevent the worker from continuing to fall. As shown in FIG. 3 and FIG. 4, one end of the driving lever 001 can trigger a locking lever 002, to make the locking lever 002 swing synchronously with the rotation of the driving lever 001. In case of falling accident, the fall of the worker drives the carabiner 003 to move, to make the driving lever 001 rotate and then drive the locking lever 002 and the wire rope to be clamped tightly to realize a locking effect.

In a traditional rope locking apparatus, the driving lever 001 is used as the triggering part of the locking member. In case of falling accident, the worker in a panic may just grab the driving lever 001 subconsciously, to make the rope locking apparatus in a state shown in FIG. 5 or FIG. 6. At this time, the driving lever 001 cannot be rotated, thus the rope locking apparatus cannot be locked in time, and then cannot protect the safety of the worker, thereby causing serious casualties.

### SUMMARY

The rope locking apparatus according to embodiments of the present application includes: a locking member, adapted to switching between a locked state and an unlocked state with a rope; a wheel, adapted to being compressed on a surface of the rope under an action of a compressing member; a rotary shaft, adapted to rotating with the wheel; a centrifugal member, which is installed on the rotary shaft and rotates with the rotary shaft, where the centrifugal member switches between a centrifugal state and a reset state as a change of a centrifugal force; a driving member, where in the centrifugal state, the centrifugal member drives the driving member to move, to drive the locking member to move to the locked state, and in the reset state, the centrifugal member is separated from the driving member, and then the locking member is in the unlocked state.

### BRIEF DESCRIPTION OF THE DRAWINGS

FIG. 1 is a schematic view of a traditional rope locking apparatus in a working state where a driving lever and a rope are clamped tightly.

FIG. 2 is a schematic view of a traditional rope locking apparatus in a working state where a driving lever and a rope are separated.

FIG. 3 is a schematic view of a traditional rope locking apparatus in a working state where a locking lever and a rope are separated.

FIG. 4 is a schematic view of a traditional rope locking apparatus in a working state where a locking lever and a rope are clamped.

FIG. 5 is a schematic view of a traditional rope locking apparatus including a locking lever in a working state, where the working state is caused by a maloperation in case of falling accident.

FIG. 6 is a schematic view of a traditional rope locking apparatus in a working state, where the working state is caused by a maloperation in case of falling accident.

FIG. 7 is a schematic diagram of a rope locking apparatus provided by an embodiment of the present application in a working state under normal conditions.

FIG. 8 is a partial exploded schematic diagram of a rope locking apparatus provided by an embodiment of the present application.

FIG. 9 is a partial structural schematic diagram of a rope locking apparatus provided by an embodiment of the present application.

FIG. 10 is a partial cross-sectional schematic view of a rope locking apparatus provided by an embodiment of the present application.

FIG. 11 is an assembly schematic diagram of a rope and a wheel provided by an embodiment of the present application.

FIG. 12 is a schematic structural diagram of a wheel provided by an embodiment of the present application.

FIG. 13 is a schematic diagram of a centrifugal flail block provided by an embodiment of the present application in a working state.

FIG. 14 is an assembly schematic diagram of a centrifugal flail block and a drum forming a limiting matching in an embodiment of the present application.

FIG. 15 is a schematic diagram of a rope locking apparatus provided by an embodiment of the present application in a locked state.

FIG. 16 is a schematic structural diagram of a rope grip jaw from a perspective in an embodiment of the present application.

FIG. 17 is a schematic structural diagram of a rope grip jaw from another perspective in an embodiment of the present application.

FIG. 18 is a schematic diagram of a rope locking apparatus provided by another embodiment of the present application in a working state under normal conditions.

FIG. 19 is a partial exploded schematic diagram of a rope locking apparatus provided by another embodiment of the present application.

FIG. 20 is a partial cross-sectional schematic diagram of a rope locking apparatus provided by another embodiment of the present application.

FIG. 21 is a schematic diagram of a centrifugal flail block provided by another embodiment of the present application in a working state.

FIG. 22 is an assembly schematic diagram of a centrifugal flail block and a drum forming a limiting matching in another embodiment of the present application.

FIG. 23 is a schematic diagram of a rope locking apparatus provided by another embodiment of the present application in a working state.

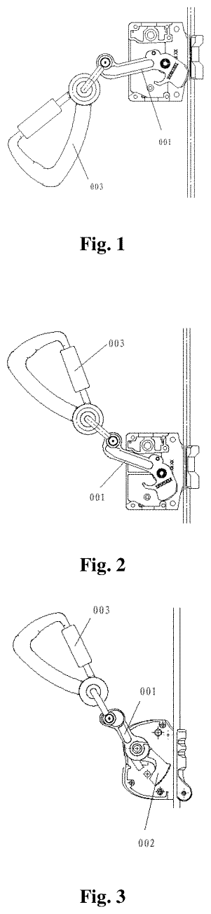

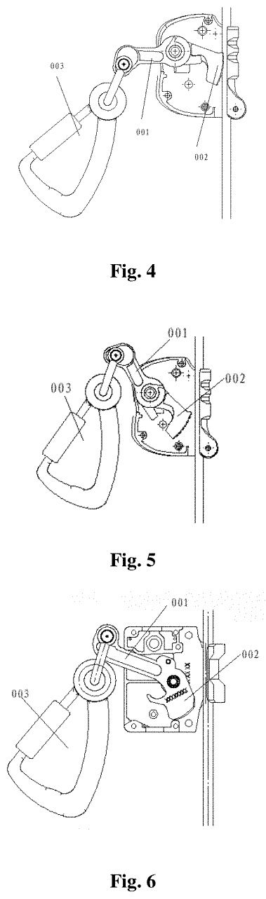

### DETAILED DESCRIPTION

The implementations of the present application are further described in detail below in conjunction with the accompanying drawings and embodiments. The following embodiments are intended to illustrate the present application, but are not intended to limit the scope of the present application.

In the description of the embodiments of the present application, it should be noted that, the orientation or positional relations indicated by terms such as “center”, “longitudinal”, “transverse”, “upper”, “lower”, “front”, “rear”, “left”, “right” , “vertical”, “horizontal”, “top”, “bottom”, “inner”, “outer” and the like are based on the orientation or positional relations shown in the drawings, which are merely convenience of description of the embodiments of the present application and to simplify description, but does not indicate or imply that the stated device or element must have the particular orientation, or be constructed and operated in a particular orientation, and thus it is not to be construed as limiting the embodiments of the present application. Furthermore, the terms “first”, “second” and “third” are used for descriptive purposes only and should not be construed as indicating or implying a relative importance.

In the description of the embodiments of the present application, it should be noted that unless explicitly stated and defined otherwise, the terms “connected to” and “connected” shall be understood broadly, for example, it may be either fixedly connected or detachably connected, or can be integrated; it may be either mechanically connected, or electrically connected; it may be either directly connected or indirectly connected through an intermediate medium. The specific meanings of the terms above in the embodiments of the present application can be understood by a person skilled in the art in accordance with specific conditions.

In the embodiments of the present application, unless explicitly stated and defined otherwise, a first feature being “up” or “down” a second feature may mean that the first feature is directly contacted with the second feature, or the first feature and the second feature are indirectly contacted through an intermediate medium. Also, a first feature being “above”, “over” and “on” a second feature may mean that the first feature is directly above or obliquely above the second feature, or simply means that a level of the first feature is higher than that of the second feature. A first feature being “below”, “under” and “down” a second feature may mean that the first feature is directly below or obliquely below the second feature, or simply means that a level of the first feature is lower than that of the second feature.

In the description of this specification, the reference terms such as “an embodiment”, “some embodiments”, “example”, “specific example”, or “some examples”, and the like mean that specific feature, structure, material or characteristic described in conjunction with the embodiment or example is included in at least one embodiment or example of the present application. In this description, schematic expressions of the above terms are not necessarily directed to the same embodiment or example. Furthermore, the described specific feature, structure, material or characteristic can be combined in any suitable manner in any one or more embodiments or examples. In addition, those skilled in the art can combine various embodiments or examples and features in various embodiments or examples described in this description unless they are contradictory.

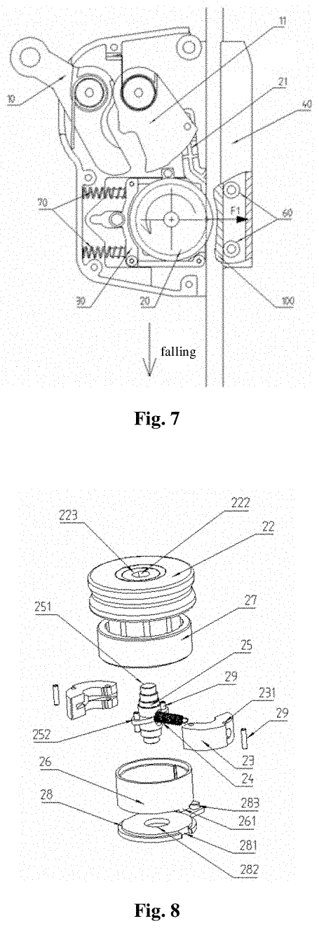

Referring to FIG. 7 to FIG. 17, a rope locking apparatus according to an embodiment of the present application includes a locking member 11, a wheel 22, a rotary shaft 25, a centrifugal member and a driving member. Where the locking member 11 is adapted to switching between a locked state and an unlocked state with a rope 100; the wheel 22 is adapted to being compressed on a surface of the rope 100 under the action of a compressing member; the rotary shaft 25 is adapted to rotating with the wheel 22; the centrifugal member is installed on the rotary shaft 25 and rotates with the rotary shaft 25, and the centrifugal member switches between a centrifugal state and a reset state as a change of a centrifugal force; and in the centrifugal state, the centrifugal member drives the driving member to move, to drive the locking member 11 to move to the locked state, and in the reset state, the centrifugal member is separated from the driving member, and then the locking member 11 is in the unlocked state.

The rope locking apparatus according to an embodiment of the present application, the centrifugal member is switched between the centrifugal state and the reset state based on the rotating speed of the rotary shaft 25. In case of falling accident, the rotary shaft has a high rotating speed, and at this time, the centrifugal member has a large centrifugal force and then the centrifugal member is switched to the centrifugal state, which drives the driving member to move, and then the locking member 11 switches to the locked state under the action of the driving member to ensure the personnel safety. The rope locking apparatus can effectively avoid the locking failure caused by external factors and ensure reliability of fall protection function. Lifting equipment with this rope locking apparatus is capable of providing better safety protection and can avoid casualty.

According to an embodiment of the present application, the rotating speed of the wheel 22 may reflect the current falling speed. When the falling speed is excessive and reaches a set speed, the wheel 22 will drive the centrifugal member to switch to the centrifugal state, to realize the locking of the locking member 11 and the rope 100. For example, when the rope locking apparatus is installed between the rope 100 and an operator, once the operator falls accidentally, the accelerated falling operator will drive the wheel 22 to rotate in an accelerated manner until the wheel 22 reaches a set speed. At this time, the centrifugal member drives the driving member to move, and the driving member drives the locking member 11 to realize locking to prevent the operator from continuing to fall. Where when the rope locking apparatus is installed between the rope 100 and the operator, the rope locking apparatus includes a carabiner for connecting the rope locking apparatus with the operator. The rope locking apparatus can also be installed between the rope 100 and an elevator or other lifting equipment.

According to an embodiment of the present application, in the phrase of “the locking member 11 is adapted to switching between a locked state and an unlocked state with a rope 100”, the locked state of the locking member 11 refers to that the locking member 11 is locked on the rope 100, and then there is a very large relative motion resistance between the locking member 11 and the rope 100, or even the relative movement between the locking member 11 and the rope 100 is impossible; and the unlocked state of the locking member 11 refers to that there is almost no resistance or very small resistance between the locking member 11 and the rope 100 during their relative movement.

According to an embodiment of the present application, “in the centrifugal state, the centrifugal member drives the driving member to move” refers to that in the centrifugal state, the centrifugal member can move to a working position, and then the centrifugal member at the working position can drive the driving member to move. In an embodiment, when the centrifugal member is in the centrifugal state, it does not mean that the centrifugal member must be able to drive the driving member to move. For example, a critical value of centrifugal force can be set for the centrifugal member, and when the centrifugal member is in a critical state while centrifugal force has not reached the critical value yet, power transmission may not be performed between the centrifugal member and the driving member at this time.

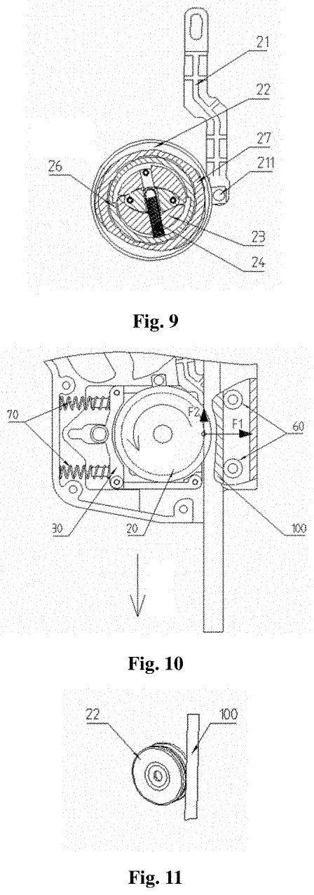

Referring to FIG. 8 and FIG. 9, the rope locking apparatus further includes a bearing 27. The bearing 27 includes a bearing inner ring and a bearing outer ring. The wheel 22 is provided with an accommodating cavity, and the bearing outer ring is installed in the accommodating cavity. The driving member includes a drum 26, and the drum 26 is installed in the bearing inner ring, where in the centrifugal state, the centrifugal member and the inner surface of the drum 26 form a limiting matching. In this case, after the wheel 22, the bearing 27 and the driving member are assembled, the bearing 27 is located in the accommodating cavity of the wheel 22, and the driving member is located in the bearing 27, and then the rope locking apparatus only occupies a very small space. In addition, since the centrifugal member and the inner surface of the drum 26 form a limiting matching, it can be ensured that in the centrifugal state, the centrifugal member drives the drum 26 to rotate, and the rotation of the drum 26 can drive the locking member 11 to realize locking. It should be noted that, the specific structural form of the limiting matching between the drum 26 and the centrifugal member is not limited, as long as the requirement of the centrifugal member to drive the drum 26 to rotate can be satisfied. Since the centrifugal member is matched with the inner surface of the drum 26, the centrifugal member is located inside the drum 26.

In an embodiment, the driving member further includes an end cover 28, and the end cover 28 is configured for closing the opening of the accommodating cavity. In addition, the end cover 28 is provided with a first limiting part, and the drum 26 is provided with a second limiting part matched with the first limiting part, and then the end cover 28 can rotate with the drum 26. The arrangement of the end cover 28 can protect components in the accommodating cavity, such as the bearing 27, the drum 26 and the centrifugal member, and ensure the normal operation of the bearing 27, the drum 26 and the centrifugal member.

In an embodiment, the rope locking apparatus includes a connecting lever 21. One end of the connecting lever 21 is hinged to the end cover 28, and another end of the connecting lever 21 is connected to the locking member 11 through a combination of a long hole and a pin shaft 29. By connecting the drum 26 and the locking member 11 through the connecting lever 21, the flexibility of the relative position between the locking member 11 and the drum 26 can be ensured, and the adaptability of the rope locking apparatus can be improved. For example, the structural form of the connecting lever 21 can be changed to adapt to the positional relationship between the locking member 11 and the drum 26.

In FIG. 8 and FIG. 9, the end cover 28 is provided with a hinge shaft 283, and the connecting lever 21 is provided with a hinge hole 211. The matching between the hinge shaft 283 and the hinge hole 211 ensures that the connecting lever 21 can rotate relative to the end cover 28 when the end cover 28 rotates. In another embodiment, the end cover 28 may be provided with a hinge hole and the connecting lever 21 may be provided with a hinge shaft, which can also realize the hinged matching between the end cover 28 and the connecting lever 21.

In an embodiment, referring to FIG. 8, the drum 26 and the end cover 28 are buckled together. For example, an end facing the end cover 28 of the drum 26 is provided with a buckle protrusion 261, and the end cover 28 is provided with a buckle groove 281. Where the positions of the buckle protrusion 261 and the buckle groove 281 can also be interchanged, for example, an end of the drum 26 is provided with a buckle groove and the end cover 28 is provided with a buckle protrusion. The first limiting portion and the second limiting portion between the drum 26 and the end cover 28 may also adopt other traditional limiting matching forms in addition to the structural forms of the buckle protrusion 261 and buckle groove 281, as long as it can be ensured that the drum 26 can drive the end cover 28 to rotate.

In an embodiment, the end cover 28 is provided with a through hole 282, a first end of the rotary shaft 25 and the wheel 22 are limiting matched, and a second end of the rotary shaft 25 passes through the through hole 282. Where after the second end of the rotary shaft 25 passes through the through hole 282, the second end of the rotary shaft 25 can be fixed by a fixing member to prevent it from withdrawing from the through hole 282, to realize the installation of the whole rope locking apparatus.

In an embodiment, the centrifugal member is a centrifugal flail block 23, a first end of the centrifugal flail block 23 is hinged to the rotary shaft 25, a second end of the centrifugal flail block 23 is provided with a first step surface, and the centrifugal flail block 23 is connected to an extension spring 24. In the centrifugal state, the extension spring 24 is in a stretched state, and in the reset state, the extension spring 24 is in a natural state. The inner surface of the drum 26 is provided with a second step surface. In the centrifugal state, the first step surface and the second step surface are limiting matched. By using the centrifugal flail block 23 as the centrifugal member, the contact strength between the centrifugal member and the inner surface of the drum 26 can be ensured. However, the structure of the centrifugal member is not limited by the examples here. For example, the centrifugal member can also be in the form of a centrifugal lever, and then when the rotational speed of the wheel 22 reaches a set speed, a limiting matching is formed between the centrifugal member and the drum 26, and then the rotary shaft 25 drives the drum 26 to rotate through the centrifugal member. In addition, the match between the first step surface and the second step surface can also ensure the structural strength of the position where the limiting matching occurs. It should be noted that the manner of limiting matching is not limited to the matching of the step surfaces.

In an embodiment, referring to FIG. 8 and FIG. 9, the number of the centrifugal flail block 23 is two, and the two centrifugal flail blocks 23 are arranged along the circumferential direction of the rotary shaft 25; second ends of the two centrifugal flail blocks 23 are connected by the extension spring 24 passing through the rotary shaft 25. In this case, the two centrifugal flail blocks 23 enclose the outer side of the rotary shaft 25, the forces on the two centrifugal flail blocks 23 are roughly equal, and then when the centrifugal flail blocks 23 drive the drum 26 to rotate, it can be ensured that the force on the drum 26 is balanced. However, the number of centrifugal flail blocks 23 is not limited by the examples here. For example, in order to enlarge the contact area or stressed area between the centrifugal member and the drum 26, the number of centrifugal flail blocks 23 can be increased. When the number of centrifugal flail blocks 23 is two, the two centrifugal flail blocks 23 are connected by the extension spring 24. When the rotary shaft 25 has a high rotating speed, the second ends of the centrifugal flail blocks 23 move toward a direction away from the rotary shaft 25 under the action of the centrifugal force, and the extension spring 24 is stretched at this time. When the speed of the rotary shaft 25 is reduced, once the restoring force of the extension spring 24 is greater than the centrifugal force of the second ends of the centrifugal flail blocks 23, the second ends of the centrifugal flail blocks 23 will move toward a direction proximal to the rotary shaft 25 under the action of the restoring force of the extension spring 24, then a motion cannot be transmitted between the centrifugal flail blocks 23 and the inner surface of the drum 26.

The “second end of the centrifugal flail block 23” is only a relative description to the “first end of the centrifugal flail block 23”. In FIG. 8, an area where the centrifugal flail block 23 and the rotary shaft 25 are hinged is the first end of the centrifugal flail block 23, then an area located downstream of the first end of the centrifugal flail block 23 in the counterclockwise direction can be defined as the second end of the centrifugal flail block 23. For example, in FIG. 8, the second end of the centrifugal flail block 23 connected to the extension spring 24 corresponds to a middle position of the centrifugal flail block 23. it should be noted that the setting position of the extension spring 24 is not limited by the examples here.

In an embodiment, the centrifugal flail block 23 is provided with a piercing hole for the extension spring 24. After the extension spring 24 passes through the rotary shaft 25, two ends of the extension spring 24 are respectively connected to the piercing holes of different centrifugal flail blocks 23, and the two ends of the extension spring 24 are fixed to the piercing holes of the centrifugal flail blocks 23 through the pin shaft 29. In this case, the disassembly and assembly of the extension spring 24 is convenient. In addition, the piercing hole and the pin shaft 29 are not necessary components to realize the installation of the extension spring 24, and other manners can also be used to realize the fixing between the extension spring 24 and the centrifugal flail block 23. Where the pin shaft 29 for fixing the extension spring 24 is installed in the fixing hole 231 of the centrifugal flail block 23.

Referring to FIG. 8, the number of corresponding centrifugal flail blocks 23 is two, the rotary shaft 25 is provided with two bosses 252 arranging symmetrically, and first ends of the two centrifugal flail blocks 23 are respectively hinged to one of the bosses 252 through the pin shafts 29. The installation of the centrifugal flail block 23 can be facilitated by the arrangement of the bosses 252.

In an embodiment, the wheel 22 includes a third limiting portion, and the rotary shaft 25 is provided with a fourth limiting portion matching with the third limiting portion, and then the rotary shaft 25 can rotate with the wheel 22. For example, the wheel 22 is formed with a non-circular hole, that is, the assembly hole 222 for assembling the rotary shaft 25 on the wheel 22 is provided with a protrusion 223. The rotary shaft 25 includes a non-circular segment 251. The structures of the protrusion 223 and the non-circular segment 251 are matched with each other, and then through the match between the non-circular hole and the non-circular segment 251, it can be ensured that the rotary shaft 25 rotates as the wheel 22 rotates. In this case, the disassembly and assembly between the wheel 22 and the rotary shaft 25 is convenient. In order to enable the wheel 22 to drive the rotary shaft 25 to rotate, the wheel 22 and the rotary shaft 25 may also be fixed by means of a screw connection or other connection.

In an embodiment, the rope locking device further includes a housing 40. Where the locking member 11, the wheel 22, the rotary shaft 25, the centrifugal member and the driving member are installed inside the housing 40. In this case, the locking member 11, the wheel 22, the rotary shaft 25, the centrifugal member and the driving member can be further protected to ensure the normal operation of the rope locking apparatus.

In an embodiment, the rope locking apparatus further includes a swing lever 10. Where one end of the swing lever 10 protrudes into the housing 40 and another end of the swing lever 10 protrudes out from the housing 40, and the swing lever 10 is adapted to switching between a first position where the swing lever 10 can drive the locking member 11 to lock with the rope 100 and a second position where the swing lever 10 is separated from the locking member 11. The arrangement of the swing lever 10 ensures that the rope locking apparatus has a manual locking function, which makes the rope locking apparatus has a double protection function. Under normal condition, as long as the operator swings the swing lever 10 manually, the locking member 11 can be driven to move to the locked state, and then the wheel 22 of the rope locking apparatus cannot roll relative to the rope 100. Under special circumstances, even if the operator operates the swing lever 10 incorrectly in a panic, since the wheel 22 itself is equivalent to having a speed sensing function, once a speed of the wheel 22 exceeds the set speed when moving, the centrifugal member drives the locking member 11 to move to the locked state through the driving member, which ensures the reliability of locking.

In an embodiment, referring to FIG. 7 and FIG. 10, the compressing member is a first compression spring 70. Where the housing 40 is connected to a first end of the first compression spring 70, and a second end of the first compression spring 70 compresses the wheel 22 on a surface of the rope 100; and the rope locking apparatus further includes a roller 60, which is arranged corresponding to the wheel 22, to make the rope 100 locate between the wheel 22 and the roller 60, which ensures that there is contact pressure between the wheel 22 and the rope 100. However, the structure of the compressing member is not limited by the examples here, as long as the wheel 22 can be prevented from slipping. Where the roller 60 is fixed on the housing 40, and the rope 100 is indirectly supported and limited through the housing 40.

In FIG. 7 and FIG. 10, the number of rollers 60 is two, and the number of first compression springs 70 is two. It should be noted that the numbers of rollers 60 and first compression springs 70 are not limited by the examples here.

In an embodiment, the rope locking apparatus includes a rope grip jaw 30 which includes a base 31. The wheel 22 is installed in the base 31, and two first compression springs 70 are arranged corresponding to upper and lower ends of the base 31. One end of the first compression spring 70 takes the housing 40 as a limiting surface, and another end of the first compression spring 70 is connected to the base 31, and then the first compression spring 70 is compressed arranged between the base 31 and the housing 40.

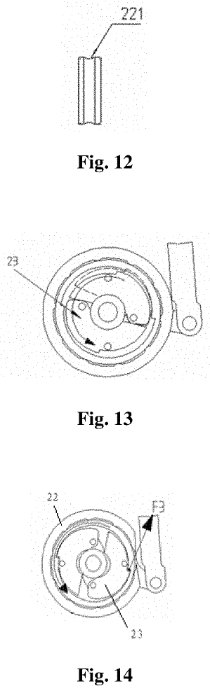

Referring to FIG. 11 and FIG. 12, the wheel 22 includes a curved outer surface 221, and the curved outer surface 221 is provided with a substantially V-shaped opening, that is, the cross-section of the wheel 22 is substantially V-shaped. In this case, the contact area between the rope 100 and an outer surface of the wheel 22 can be ensured, to prevent the wheel 22 from slipping. The outer surface of the wheel 22 can also adopt other structural forms that are beneficial to the rolling of the wheel 22. For example, the surface friction coefficient of the wheel 22 can be increased, or a U-shaped opening can be formed on the outer surface of the wheel 22 and bulge structures can be set on side walls on two sides of the U-shaped opening to increase the frictional force between the wheel 22 and the rope 100.

According to an embodiment of the present application, the rope 100 may be a steel wire rope, a chain, or other structural forms, as long as it is suitable for an operator or a lifting device to ascend and descend along it.

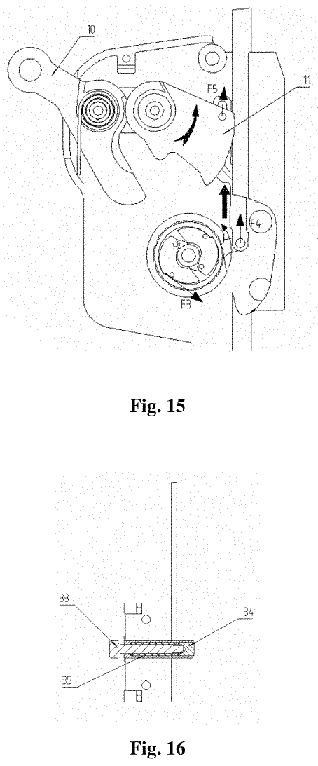

Referring to FIG. 8, FIG. 10 and FIG. 13 to FIG. 15, in case of falling accident, the rope locking apparatus moves downward relative to the rope 100 (the downward arrow direction in FIG. 10 shows the moving direction of the rope locking apparatus relative to the rope), at this time, the wheel 22 rotates along the counterclockwise arrow in FIG. 10. There is a compressing force F1 between the wheel 22 and the rope 100, and there is a friction force F2 between the rope 100 and the wheel 22, which make the wheel 22 rotate counterclockwise. When the wheel 22 rotates, it also drives the rotary shaft 25 to rotate counterclockwise. Under the action of centrifugal force, the centrifugal flail block 23 hinged on the boss 252 rotates with the pin shaft 29 as a center. Referring to FIG. 13, the dot line shows the position where the centrifugal flail block 23 is in a centrifugal state. The first step surface of the centrifugal flail block 23 is in contact with the second step surface of the inner surface of the drum 26 to generate a force F3 on the drum 26 to make it rotate counterclockwise. Because of the matching relationship between the drum 26 and the end cover 28, an upward driving force F4 on the connecting lever 21 is generated at the hinge shaft 283 of the end cover 28, to drive the connecting lever 21 to move upward. And then an upward force F5 is generated at the position where the connecting lever 21 is connected to the locking member 11. F5 drives the locking member 11 to rotate counterclockwise until the locking member 11 and the rope 100 are clamped together, thereby realizing the locking function of the rope locking apparatus. In FIG. 15, the rotating direction of the locking member 11 corresponds to the swinging direction of the locking member 11; and the vertical upward direction of the connecting lever 21 refers to that the connecting lever 21 moves upward to drive the locking member 11.

In an embodiment, the locking member 11 adopts a structural form of an irregular locking lever. It should be noted that the structural forms of the locking member 11 are not limited by the examples here, and it can also adopt a regular structural form, and can also adopt any other irregular structural forms, as long as it can realize the unlocking and locking with the rope 100.

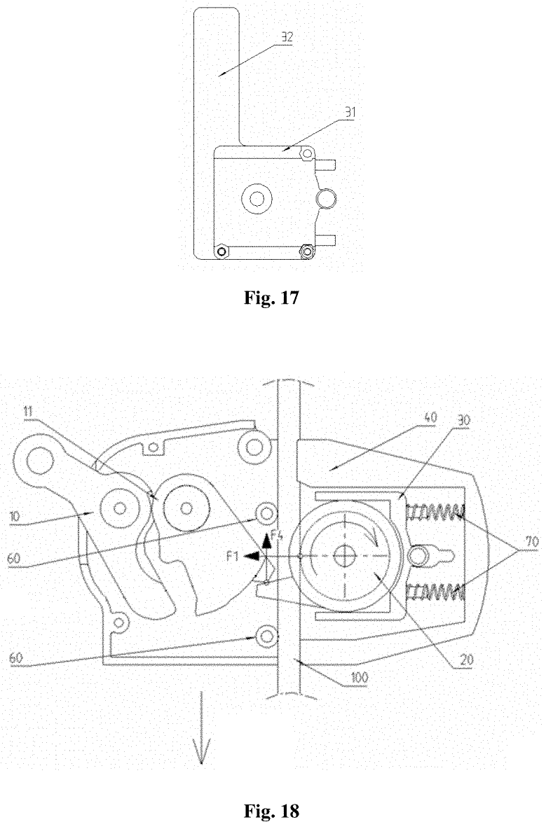

In an embodiment, referring to FIG. 16 and FIG. 17, the rope grip jaw 30 includes a base 31, a rope grip plate 32, a push button 33, a cap 34 and a second compression spring 35. The rope grip jawing plate 32 is connected to the base 31 through a hexagon socket countersunk head screw, a M3×8 screw and a M3 nut. The push button 33 is T-shaped. The shaft portion of the push button 33 passes through a hole on the base 31, sleeves the second compression spring 35 into the shaft portion of the push button 33 from another side, and locks it tightly through the cap 34.

According to an embodiment of the present application, the rope locking apparatus includes a speed sensing assembly 20. Where the speed sensing assembly 20 includes components such as a wheel 22, a bearing 27, a rotary shaft 25, a centrifugal flail block 23, a drum 26, an end cover 28 and a connecting lever 21.

According to an embodiment of the present application, the setting positions of the locking member 11 and the wheel 22 are not limited, as long as the centrifugal member installed on the rotary shaft 25 can transmit the motion to the locking member 11 when the rolling speed of the wheel 22 along the rope 100 has reached the set speed. For example, in FIG. 7, the locking member 11 is located above the wheel 22, and in FIG. 18, the locking member 11 and the wheel 22 are located on two sides of the rope 100 respectively.

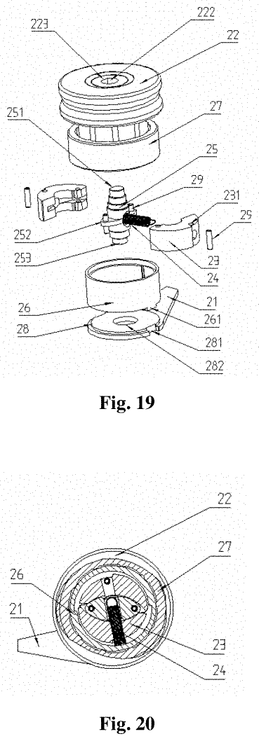

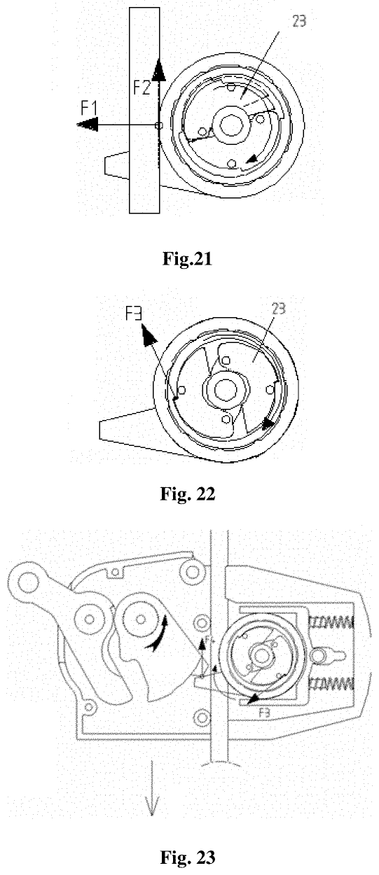

Referring to FIG. 18 to FIG. 23, a connecting lever 21 provided by the embodiment of the present application is formed on the end cover 28, the connecting lever 21 is provided with a first triggering surface, and the locking member 11 is provided with a second triggering surface matching with the connecting lever 21. The first triggering surface and the second triggering surface are arranged opposite to each other.

According to an embodiment of the present application, under the action of gravity, the locking member 11 and the connecting lever 21 do not interact with each other under normal conditions, and the locking member 11 is in an unlocked state at this time. Only when the wheel 22 has a relatively high speed, the connecting lever 21 rotates under the action of the centrifugal member, to drive the locking member 11 to rotate to the locked state. It should be noted that the connecting lever 21 is not an essential component. For example, a limiting matching can also be formed directly between the drum 26 and the locking member 11, and then when the drum 26 rotates, it can drive the locking member 11 to rotate a locked position.

The above embodiments are only used to illustrate the solutions of the present application, but not to limit it. Although the present application has been described in detail with reference to the embodiments, those of ordinary skill in the art should understand that various combinations, modifications or equivalent replacements made to the solutions of the present application do not depart from the scope of the solutions of the present application, and should be covered by the scope of the claims of the present application.

1. A rope locking apparatus, comprising:
a locking member, adapted to switching between a locked state and an unlocked state with a rope;
a wheel, adapted to being compressed on a surface of the rope under an action of a compressing member;
a rotary shaft, adapted to rotating with the wheel;
a centrifugal member, which is installed on the rotary shaft and rotates with the rotary shaft, wherein the centrifugal member switches between a centrifugal state and a reset state as a change of a centrifugal force; and
a driving member, wherein in the centrifugal state, the centrifugal member drives the driving member to move, to drive the locking member to move to the locked state, and in the reset state, the centrifugal member is separated from the driving member, and then the locking member is in the unlocked state.

2. The rope locking apparatus according to claim 1, further comprising:
a bearing, comprising a bearing inner ring and a bearing outer ring;
wherein the wheel is provided with an accommodating cavity where the bearing outer ring is installed; and
the driving member comprises a drum which is installed in the bearing inner ring, and in the centrifugal state, the centrifugal member and an inner surface of the drum form a limiting matching, and then when the centrifugal member rotates, the centrifugal member drives the drum to rotate, and the drum drives the locking member to move to the locked state.

3. The rope locking apparatus according to claim 2, wherein the driving member further comprises:
an end cover, configured for closing an opening of the accommodating cavity, wherein the end cover is provided with a first limiting part, and the drum is provided with a second limiting part matching with the first limiting part, and then the end cover rotates with the drum; and
a connecting lever, one end of the connecting lever is hinged to the end cover, and another end of the connecting lever is adapted to rotating with the end cover to drive the locking member to move to the locked state.

4. The rope locking apparatus according to claim 2, wherein the centrifugal member is a centrifugal flail block, a first end of the centrifugal flail block is hinged to the rotary shaft, a second end of the centrifugal flail block is provided with a first step surface, and the centrifugal flail block is connected to an extension spring, wherein in the centrifugal state, the extension spring is in a stretched state, and in the reset state, the extension spring is in a natural state; and
the inner surface of the drum is provided with a second step surface, wherein in the centrifugal state, the first step surface and the second step surface are limiting matched.

5. The rope locking apparatus according to claim 4, wherein the number of the centrifugal flail blocks is two, and the two centrifugal flail blocks are arranged along the circumferential direction of the rotary shaft;
second ends of the two centrifugal flail blocks are connected by the extension spring passing through the rotary shaft; and
the rotary shaft is provided with two bosses arranging symmetrically, and first ends of the two centrifugal flail blocks are respectively hinged to one of the bosses.

6. The rope locking apparatus according to claim 1, wherein the wheel comprises a third limiting portion, and the rotary shaft is provided with a fourth limiting portion matching with the third limiting portion, and then the rotary shaft rotates with the wheel.

7. The rope locking apparatus according to claim 1, further comprises:
a housing, wherein the locking member, the wheel, the rotary shaft, the centrifugal member and the driving member are installed inside the housing; and
a swing lever, wherein one end of the swing lever protrudes into the housing and another end of the swing lever protrudes out from the housing, and the swing lever is adapted to switching between a first position where the swing lever drives the locking member to lock with the rope and a second position where the swing lever is separated from the locking member.

8. The rope locking apparatus according to claim 7, wherein the compressing member is a first compression spring, the housing is connected to a first end of the first compression spring, and a second end of the first compression spring compresses the wheel on the surface of the rope;
the rope locking apparatus further comprises:
a roller, arranged corresponding to the wheel, and then the rope is located between the wheel and the roller.

9. The rope locking apparatus according to claim 1, wherein the locking member and the wheel are distributed along the length direction of the rope.

10. The rope locking apparatus according to claim 1, wherein the locking member and the wheel are located on two sides of the rope.
